(19) United States
(12) Patent Application Publication
(10) Pub. No.: US 2012/0219262 A1
(43) Pub. Date: Aug. 30, 2012

(54) Optical Fiber Management Drawer with Slack Management Features

(76) Inventors: Walter Mark Hendrix, Richardson, TX (US); Douglas L. Williams, Omaha, NE (US); Stephen P. Watson, Richardson, TX (US); Charles J. Mann, Omaha, NE (US); Manikandan Ramachandran, Chennai (IN); Pankaj Gupta, Dehradun (IN); Stephen Kumar Chandran, Ponmeni (IN); Gunaseelan Swaminathan, Tamilnadu (IN)

(21) Appl. No.: 13/196,951

(22) Filed: Aug. 3, 2011

Related U.S. Application Data
(60) Provisional application No. 61/447,112, filed on Feb. 28, 2011.

(51) Int. Cl. G02B 6/46

(52) U.S. Cl. 385/135

(57) ABSTRACT

A fiber management device includes a support member including a first connector for releasably securing a first sidewall portion of an optical fiber bundle to the support member at a first fixed location and a drawer mounted for sliding movement relative to the support member, the drawer including a mounting surface, a plurality of fiber guiding components mounted on the mounting surface, and a second connector for releasably securing a second sidewall portion of the optical fiber bundle to the drawer at a second fixed location.

### CROSS-REFERENCE TO RELATED APPLICATIONS

The present application claims the benefit of U.S. Provisional Patent Application No. 61/447,112, filed Feb. 28, 2011, the entire contents of which are hereby incorporated by reference.

### FIELD OF THE INVENTION

The present invention is directed to a fiber management device having connectors for securing one or more optical fiber bundles to a drawer or support structure, and, more specifically, to a fiber management device having a plurality of connectors for securing portions of one or more optical fiber bundles to fixed locations on a drawer and/or a support structure near the drawer.

### BACKGROUND OF THE INVENTION

For rack mounted telecommunications equipment in both central office and outside plant applications, fiber optic cables and interconnects must be properly managed to ensure network reliability. To decrease the space required for mounting and storing these interconnects, the fibers and their interconnects are often mounted to sliding panels which are mounted in close proximity to one another and which can be slid open like a drawer to allow access to the fibers and interconnects. The drawer is then closed again to protect the components and reduce the volume required for housing a given number of fibers and fiber bundles and fiber interconnects.

A problem that arises with such arrangements is managing the fiber bundles as they approach the sliding panel and leave the sliding panel. If insufficient slack is provided in the fiber bundle, the drawer will not be able to move between open and closed positions without stressing or breaking the optical fibers or the interconnects. If too much slack is provided, however, the fiber bundles may become kinked or tangled or may interfere with the free movement of the drawers.

It is known in the prior art to provide special interfaces for connecting optical fiber bundles to sliding drawers, which interfaces may include slide elements that slide relative to a drawer surface to and which move as the drawer slides to help manage the location of the fiber bundles as the drawers move. However, such slide elements add to the cost and complexity of optical fiber management devices and constitute an additional point of failure. It would therefore be desirable to manage optical fiber bundles in a drawer-type optical fiber management device that is simple and reliable.

### SUMMARY OF THE INVENTION

These problems and others are addressed by embodiments of the present invention, a first aspect of which comprises a fiber management device having a support member with a first connector for releasably securing a first sidewall portion of an optical fiber bundle to the support member at a first fixed location and a drawer. The drawer is mounted for sliding movement relative to the support member and includes a mounting surface. There are a plurality of fiber guiding components mounted on the mounting surface, and the mounting surface also includes a second connector for releasably securing a second sidewall portion of the optical fiber bundle to the drawer at a second fixed location.

Another aspect of the invention comprises a fiber management device comprising a support member with a first connection arrangement for releasably securing a first sidewall portion of an optical fiber bundle to the support member at a first fixed location and a drawer mounted for sliding movement relative to the support member. The drawer includes a mounting surface, a plurality of fiber guiding components mounted on the mounting surface, and a second connection arrangement for releasably securing a second sidewall portion of the optical fiber bundle to the drawer at a second fixed location.

A further aspect of the invention comprises a fiber management device including a housing, a drawer support mounted to the housing and a drawer slidably mounted to the drawer support for sliding movement between closed and open positions. The drawer has a front edge, a rear edge, a mounting surface and a plurality of fiber guiding components mounted on the mounting surface. A first connector for releasably securing a first sidewall portion of a first optical fiber bundle to a first fixed location is located on the housing or on the drawer support. A second connector for releasably securing a second sidewall portion of the first optical fiber bundle to a second fixed location on the drawer is located on the drawer. A third connector is provided on the housing or the drawer support for releasably securing a first sidewall portion of a second optical fiber bundle to a third fixed location on the housing or the drawer support, and a fourth connector is provided on the drawer for releasably securing a second sidewall portion of the second optical fiber bundle to a fourth fixed location on the drawer.

### BRIEF DESCRIPTION OF THE DRAWINGS

These and other features and aspects of the invention will be better understood after a reading of the following detailed description together with the attached drawings wherein:

FIG. 1 is side elevational view of a fiber management drawer in a retracted position relative to a housing showing first and second optical fiber bundles associated with the drawer.

FIG. 2 is a side elevational view of the drawer of FIG. 1 in an extended position relative to the housing.

FIG. 3 is a front elevational view of the drawer of FIG. 1.

FIG. 4 is a front elevational view of a second embodiment of a fiber management drawer according to the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

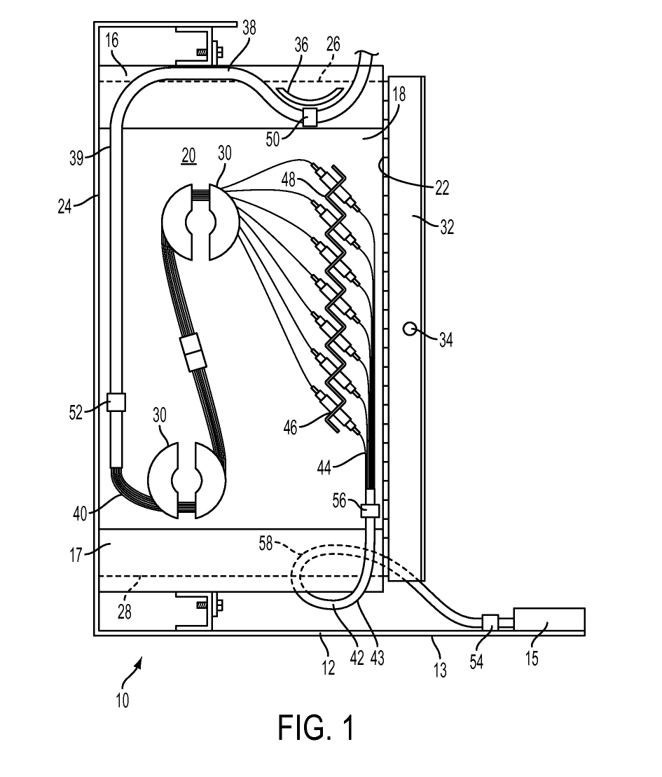

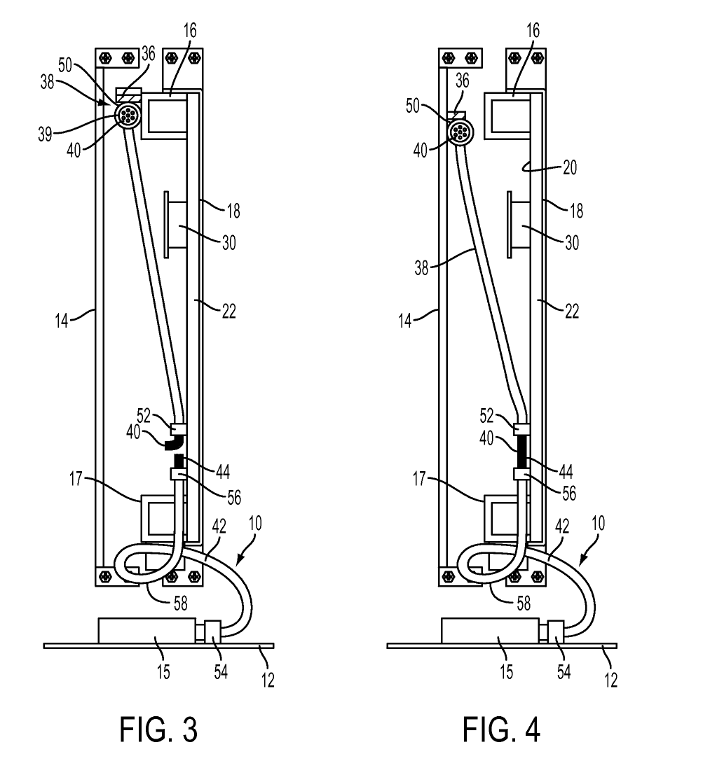

FIG. 1 illustrates a housing 10 such as a fiber management cabinet that includes a floor 12 having an edge 13 and a fiber management box 15 near edge 13. A door or other cover (not illustrated) may be provided for selectively closing housing 10 to protect optical fibers and other elements therein. A plurality of support members are provided in housing 10 including an upper drawer support 16, a lower drawer support 17 and vertical supports or walls 14 (illustrated in FIGS. 3 and 4). A drawer 18 is mounted to the upper and lower drawer supports 16, 17 and includes a mounting surface 20 having an outer edge 22, an inner edge 24, a top edge 26 and a bottom edge 28. A plurality of fiber guiding components 30 are mounted on mounting surface 20, which fiber guiding elements 30 may be repositioned as desired by mounting them in selected ones of a plurality of mounting openings (not illustrated) on the mounting surface 20. A hinged door 32 is connected to outer edge 22 for protecting the fiber guiding components 30 and any optical fibers mounted thereto when drawer 18 is in a retracted portion relative to the upper and lower drawer supports 16, 17. It should be noted that drawer 18 can alternately be mounted in a horizontal orientation (not illustrated) and that, when mounted horizontally, the top and bottom edges would be located at the right and left sides of the drawer. A handle 34 is mounted on hinged door 32 and is used to open door 32 and to pull drawer 18 from within housing 10 to access mounting surface 20, and a suitable latching mechanism (not illustrated), magnetic or otherwise, may also be provided to hold the hinged door 32 closed. A bend limiter 36 is mounted on the upper drawer support 16 for reasons discussed below.

A first optical fiber bundle 38 comprising a first sheath 39 containing a plurality of first optical fibers 40 and a second optical fiber bundle 42 comprising a second sheath 43 containing a plurality of second optical fibers 44 are also illustrated in FIG. 1, each of which first and second sheaths 39, 43 comprises a flexible tube. First optical fibers 40 from first optical fiber bundle 38 wrap around first and second ones of the fiber guiding components 30 and connect to a first side of adapters 46 on a bulkhead 48. Second optical fibers 44 from second optical fiber bundle 42 connect to a second side of adapters 46 on bulkhead 48. The first optical fibers 40 and second optical fibers 44 themselves are connected to adapters 46 in a conventional manner. However, the first and second optical fiber bundles 38, 42 require attachment to the housing 10 or its internal components in a manner that maintains the first and second optical fiber bundles 38, 42 and the fibers they contain in a desired position while at the same time allowing the drawer 18 to slide relative to the upper and lower drawer supports 16, 17. The attachment arrangement must also avoid bending or stressing the first and second optical fibers 40, 44 and their connections to adapters 46 as drawer 18 moves.

To this end, a first connector 50 is provided at upper drawer support 16, on bend limiter 36, for example, a second connector 52 is provided at inner edge 24 of drawer 18, a third connector 54 is provided on housing floor 12 near fiber management box 15, and a fourth connector 56 is provided at outer edge 22 of drawer 18 near hinged door 32. Each of the first, second, third and fourth connectors 50, 52, 54 and 56 comprises a length of flexible material that can be opened and closed around a sidewall portion of one of the first and second optical fiber bundles 38, 42 to secure that sidewall portion of the first or second optical fiber bundle 38, 42 to the location where the connector is affixed. The connectors may comprise hook and loop fastener material, for example, or flexible bands having a buckle or ratcheting lock (not illustrated) or similar fasteners that can surround and fasten the first and second fiber bundles 38, 42 in place, preferably in a releasable manner. While these connectors may flex to some degree, the are generally sufficiently rigid to maintain the first optical fiber bundles 38, 42 in a given position and orientation. Each of the first through fourth connectors 50, 52, 54, 56 is generally circular in cross section in order to surround and engage the tubular sidewall portions of the first and second optical fiber bundles 38, 42. Each connector includes a centerline, and reference is also made herein to a plane that is perpendicular to this centerline for purposes of discussing the location and orientation of the connectors relative to each other and to the drawer 18.

When drawer 18 is in a closed configuration relative to housing 10, as shown in FIG. 1, first optical fiber bundle 38 approaches bend limiter 36 from a first side of the centerline of the first connector 50 and travels along the bend limiter to first connector 50 which encircles a first sidewall portion of the first optical fiber bundle 38 to connect that first sidewall portion of the first optical fiber bundle 38 to the bend limiter 36 and upper drawer support 16. The first optical fiber bundle 38 continues to follow the curve of bend limiter 36 back toward the first side of the centerline of the first connector 50 and travels along the drawer support 16 near top edge 26 of drawer 18 toward the inner edge 24 of drawer 18. As the first optical fiber bundle 38 approaches the inner edge 24 of drawer 18, it turns in the direction of the bottom edge 28 of drawer 18, crosses the centerline of the first connector 50 to a second side of the centerline of the first connector 50 and travels along the inner edge 24 of drawer 18 to second connector 52, which is located near the inner edge 24 of the drawer 18 and has a centerline generally parallel to the inner edge 24 of the drawer 18. Second connector 52 surrounds a second sidewall portion of the first optical fiber bundle 38 to secure the first optical fiber bundle 38 to the drawer 18 near the inner edge 24. The plurality of optical fibers 40 exit the first sheath 39 near the inner edge 24 of the drawer 18 and travel around fiber guiding elements 30 on mounting surface 20 of drawer 18 until they reach adapters 46 on a bulkhead 48 near the outer edge 22 of drawer 18. The transition of the first optical fiber bundle 38 from the plane of the upper drawer support 16 to the plane of the mounting surface 20 can be seen in FIG. 3 in which hinged door 32 and bulkhead 48 have been removed for illustration purposes.

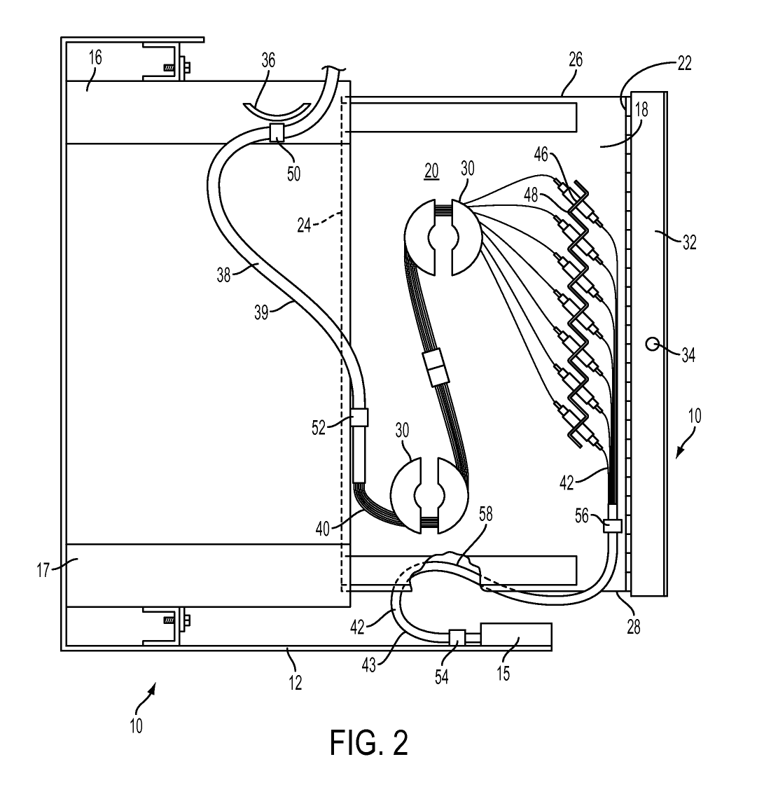

When the drawer 18 slides from the closed configuration of FIG. 1 to the open configuration of FIG. 2, the portions of first optical fiber bundle 38 that are not between the first connector 50 and the second connector 52 remain generally fixed. That is, the movement of the drawer 18 does not flex or stress the portion of first optical fiber bundle 38 or first optical fibers 40 between second connector 52 and the fiber guiding elements 30 or the portion of first optical fiber bundle 38 that leads away from first connector 50 and drawer 18. A plane (not illustrated) passes through first connector 50 perpendicular to the centerline of the first connector 50. As the drawer 18 moves toward the open configuration illustrated in FIG. 2, the second connector 52 passes from one side of this plane to the other, and the portion of first optical fiber bundle 38 between the first connector 50 and the second connector 52 flexes to move with the drawer 18 and assumes a generally S-shaped curvature in a manner that does not kink or exceed the bend radius of the first optical fibers 40 contained within the first sheath 39. The portion of first optical fiber bundle 38 between the first connector 50 and the second connector 52 flexes back to the starting position illustrated in FIG. 1 when drawer 18 is shifted from the open to the closed position. This mounting arrangement has been found to advantageously provide sufficient slack to avoid damage to the first and second fiber bundles 38, 42, and first and second fibers 40, 44 contained therein without interfering with drawer movement and without the need for complicated slack management structures as used in the prior art.

Referring again to FIG. 1, the second optical fibers 44, comprising patch cords, for example, are connected to adapters 46 on bulkhead 48 on the side of bulkhead 48 opposite from the location where first optical fibers 40 connect to adapters 46. These second optical fibers 44 enter second sheath 43, and the second optical fiber bundle 42 comprised of the second optical fibers 44 and the second sheath 43 is connected to drawer 18 near its outer edge 22 by fourth connector 56 which fourth connector 56 has a centerline generally aligned with the outer edge 22 of drawer 18. Second optical fiber bundle 42 runs past the lower drawer support 17 toward floor 12 of housing 10 and under bottom edge 28 of drawer 18 to form a loop 58 on or near floor 12. The second optical fiber bundle 42 is connected to floor 12 of housing 10 by a third connector 54 near fiber management box 15 which third connector 54 encircles a sidewall portion of the second optical fiber bundle 42, and the second optical fiber bundle 42 and/or second optical fibers 44, enter fiber management box 15 after exiting the third connector 54. Third connector 54 has a centerline that is generally perpendicular to edge 13 and generally perpendicular to the centerline of the second connector 52 and to the centerline of the fourth connector 56.

As drawer 18 slides from the closed position illustrated in FIG. 1 to the open position illustrated in FIG. 2, the portion of second optical fiber bundle 42 and second optical fibers 44 between fourth connector 56 and bulkhead 48 remains essentially fixed relative to drawer 18, and the portion of second optical fiber bundle 42 between third connector 54 and fiber management box 15 remains essentially fixed relative to housing floor 12. However, the portion of second optical fiber bundle 42 between third connector 54 and fourth connector 56 including loop 58 deforms as drawer 18 moves, and in this process, fourth connector 56 moves from a first side of a plane which runs perpendicularly to the centerline of the third connector 54 to a second side of that plane to the position illustrated in FIG. 2.

A second embodiment of the invention is illustrated in FIG. 4 in which elements common to the first embodiment are identified with like reference numerals. This embodiment is substantially identical to the first embodiment except that bend limiter 36 is mounted to support wall 14 lying next to the upper drawer support 16 instead of to the upper drawer support 16 itself. Bend limiter 36 in this position is located only a small distance away from the upper drawer support 16, and first optical fiber bundle 38 travels toward second connector 52 along inner edge 24 of drawer 18 substantially as in the first embodiment. The transition of the first optical fiber bundle 38 from the bend limiter 36 in the plane of wall 14 to the parallel mounting surface 20 of drawer 18 can be seen in FIG. 4 in which hinged door 32 and bulkhead 58 have been removed for illustration purposes.

The foregoing arrangements allow the free movement of a drawer 18 containing fiber guiding components 30 and associated first and second optical fiber bundles 38, 42 without applying significant stress to the first and second optical fibers 40, 44 or their connections to the adapters 46 in a simple manner that does not require the use of separate movable components as were sometimes required in the prior art.

The present invention has been described herein in terms of presently preferred embodiments. Modifications and additions to these embodiments will become apparent to those of ordinary skill in the relevant art upon a reading of the foregoing description. It is intended that all such modifications comprise a part of the present invention to the extent they fall within the scope of the several claims appended hereto.

What is claimed is:

1. A fiber management device comprising:
a support member including a first connector for releasably securing a first sidewall portion of an optical fiber bundle to said support member at a first fixed location;
a drawer mounted for sliding movement relative to said support member, said drawer including a mounting surface, a plurality of fiber guiding components mounted on said mounting surface, and a second connector for releasably securing a second sidewall portion of the optical fiber bundle to said drawer at a second fixed location.

2. The fiber management device of claim 1, wherein at least one of said first connector and said second connector comprises a loop of flexible material.

3. The fiber management device of claim 2, wherein at least one of said first connector and said second connector comprise hook and loop fastening material.

4. The fiber management device of claim 1, wherein said first connector comprises a first loop of flexible material, said first loop having a centerline and said second connector comprises a second loop of flexible material, said second loop having a centerline.

5. The fiber management device of claim 4, wherein the centerline of said first loop is perpendicular to the centerline of said second loop.

6. The fiber management device of claim 4, wherein said drawer moves in a sliding direction and wherein the centerline of said first loop extends in said sliding direction.

7. The fiber management device of claim 4, wherein said drawer moves in a sliding direction and wherein the centerline of said second loop is perpendicular to said sliding direction.

8. The fiber management device of claim 6, wherein the centerline of said second loop is oriented perpendicularly to said sliding direction.

9. The fiber management device of claim 4, wherein said support member includes a curved bend limiting element and wherein said first loop of flexible material is mounted on said bend limiting element.

10. The fiber management device of claim 4, wherein said drawer is shiftable from a first position to a second position relative to said support member, wherein a plane passing through said first loop extends perpendicular to the centerline of the first loop and wherein said second loop shifts from a first side of said plane to a second side of said plane when said drawer shifts from said first position to said second position.

11. The fiber management device of claim 4, including an optical fiber bundle extending through said first loop and said second loop, said optical fiber bundle approaching said first loop from a first side of said first loop centerline, exiting said first loop toward the first side of said first loop centerline and then crossing said first loop centerline to a second side of said first loop centerline between the first loop and the second loop.

12. The fiber management device of claim 4, wherein said second connector is arranged at a rear edge of said drawer.

13. The fiber management device of claim 4, wherein said second connector is arranged at a front edge of said drawer.

14. The fiber management device of claim 1, including a third connector comprising a loop of flexible material for releasably securing a first sidewall portion of a second optical fiber bundle to a support structure fixed relative to said support member and a fourth connector comprising a loop of flexible material for releasably securing a second sidewall portion of the second optical fiber bundle to said drawer.

15. The fiber management device of claim 14, wherein said second connector is located at the rear of said drawer and the fourth connector is located at the front of the drawer.

16. A fiber management device comprising:
a support member including first connection means for releasably securing a first sidewall portion of an optical fiber bundle to said support member at a first fixed location;
a drawer mounted for sliding movement relative to said support member, said drawer including a mounting surface, a plurality of fiber guiding components mounted on said mounting surface, and second connection means for releasably securing a second sidewall portion of the optical fiber bundle to said drawer at a second fixed location.

17. A fiber management device comprising:
a housing;
a drawer support mounted to the housing;
a drawer slidably mounted to the drawer support for sliding movement between closed and open positions, the drawer having a front edge, a rear edge, a mounting surface and a plurality of fiber guiding components mounted on said mounting surface;
a first connector for releasably securing a first sidewall portion of a first optical fiber bundle to a first fixed location on said housing or on said drawer support;
a second connector for releasably securing a second sidewall portion of the first optical fiber bundle to a second fixed location on said drawer;
a third connector for releasably securing a first sidewall portion of a second optical fiber bundle to a third fixed location on said housing or said drawer support; and
a fourth connector for releasably securing a second sidewall portion of the second optical fiber bundle to a fourth fixed location on said drawer.

18. The fiber management device of claim 17, wherein each of said first, second, third and fourth connectors comprises a loop of flexible material having a centerline, wherein the fourth connector shifts from a first side of said third connector to a second side of said third connector when said drawer shifts from a fully closed position to a fully opened position.

19. The fiber management device of claim 18, including a first optical fiber bundle extending though said first connector and said second connector and a second optical fiber bundle extending through said third connector and said fourth connector, said first connector being mounted on a curved bend limiting structure on said drawer support, said first optical fiber bundle following a curvature of said curved bend limiting structure, a first length of said first optical fiber bundle between said first connector and said second connector lying to a first side of the centerline of the first connector and a second length of the first optical fiber bundle between said first connector and said second connector lying to a second side of the centerline of the first connector, the second connector being mounted at the rear edge of the drawer, the third connector being mounted to the housing at a position spaced from the drawer support, and the fourth connector being mounted at the front edge of the drawer.

20. The fiber management device of claim 19, wherein said first, second, third and fourth connectors comprise hook and loop fastening material.
